(19) United States
(12) Patent Application Publication
(10) Pub. No.: US 2010/0114928 A1
(43) Pub. Date: May 6, 2010

(54) DIVERSE QUERY RECOMMENDATIONS USING WEIGHTED SET COVER METHODOLOGY

(75) Inventors: Francesco Bonchi, Barcelona (ES); Aristides Gionis, Barcelona (ES); Debora Donato, Barcelona (ES)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/265,936

(22) Filed: Nov. 6, 2008

(51) Int. Cl. G06F 17/30; G06F 7/00

(52) U.S. Cl. 707/759; 707/E17.008; 707/E17.014; 707/E17.017

(57) ABSTRACT

A computer-implemented method is such that suggested search queries are provided based on an input search query. The search query is received (such as from a user providing the search query to a search engine service) and a first list of documents is determined that correspond to processing the query by a search engine. A list of result queries is determined, wherein executing the list of result queries would correspond to a second list of documents, that result from presenting the result queries to the search engine, and the documents of the second list of documents cover the documents of the first list of documents. The list of result queries is returned as the suggested queries. Determining a list of result queries may include, for example, determining a list of potential queries, wherein each potential query, when executed by the search engine, results in at least one document in the first list of documents; and processing the potential queries to determine which of the potential queries to include in the list of result queries.

### BACKGROUND

As the internet has become ubiquitous, many times, a search engine is the first stop for a user attempting to find information on the internet about a particular subject. It has been observed that, many times, the queries user typically enter are quite short, and a reason for this may be that the user has inadequate knowledge (at least initially, prior to viewing any search results) with which to specify a query more precisely.

Many search engines thus offer query recommendations in response to queries that are received by the search engine. These recommendations are typically obtained by analyzing logs of past queries, and return recommended queries that are similar to the query entered by the user, such as by clustering of previous queries or by identifying frequent re-phrasings.

There has been a fair amount of work in the area of query recommendations. For example, in J.-R. Wen, J.-Y. Nie, H.-J. Zhang, and H.-J. Zhang, Clustering user queries of a search engine. In Proceedings of the 10th int. conf. on World Wide Web (WWW'01), queries are clustered using a density-based clustering algorithm on the basis of four different notions of distance: based on keywords or phrases of the query, based on string matching of keywords, based on common clicked URLs, and based on the distance of the clicked documents in some pre-defined hierarchy.

Also the work in D. Beeferman and A. Berger, Agglomerative clustering of a search engine query log, In Proceedings of the sixth ACM SIGKDD int. conf. on Knowledge discovery and data mining (KDD'00), proposes a query clustering technique based on common clicked URLs: the query log is represented as a bipartite graph with the vertices on one side representing queries and on the other side URLs. An agglomerative clustering is performed on the graph's vertices to identify related queries and URLs. The algorithm is content agnostic, as it makes no use of the actual content of the queries and URLs, but instead it only focuses on co-occurrences in the query log. As stated in R. A. Baeza-Yates, C. A. Hurtado, and M. Mendoza, Query recommendation using query logs in search engines, In EDBT Workshops, pages 588-596, 2004, the distance measures discussed above have real-world practical limitations when it comes to identifying similar queries, because two related queries may output different URLs in the first places of their answer sets, thus inducing clicks in different URLs (given that the user clicks are affected by the ordering of the URLs. See N. Craswell, O. Zoeter, M. Taylor, and B. Ramsey, An experimental comparison of click position-bias models, In Proceedings of the international conference on Web search and web data mining (WSDM'08)).

Moreover, as empirically shown e.g. in B. J. Jansen and A. Spink, How are we searching the world wide web? a comparison of nine search engine transaction logs, Information Processing & Management, 42(1):248-263, January 2006, the average number of pages clicked per answer is very low. To overcome these limitations, the work in R. A. Baeza-Yates, C. A. Hurtado, and M. Mendoza, Query recommendation using query logs in search engines, In EDBT Workshops, pages 588-596, 2004, clusters queries by representing them as term-weighted vectors obtained by aggregating the term-weighted vectors of their clicked URLs. A different approach to query clustering for recommendation is in Z. Zhang and O. Nasraoui, Mining search engine query logs for query recommendation. In Proceedings of the 15th int. conf. on World Wide Web, (WWW'06), where two different methods are combined. The first method is obtained by modeling search engine users' sequential search behavior, and interpreting this consecutive search behavior as client-side query refinement, that should form the basis for the search engine's own query refinement process. The second method is a traditional content-based similarity method used to compensate for the high sparsity of real query log data, and more specifically, the shortness of most query sessions. The two methods are combined together to form a similarity measures for queries. Association rule mining has also been used to discover related queries in B. M. Fonseca, P. B. Golgher, E. S. de Moura, B. Pôssas, and N. Ziviani, Discovering search engine related queries using association rules, J. Web Eng., 2(4), 2004. The query log is viewed as a set of transactions, where each transaction represent a session in which a single user submits sequence of related queries in a time interval.

### SUMMARY

A computer-implemented method is such that suggested search queries are provided based on an input search query. The search query is received (such as from a user providing the search query to a search engine service) and a first list of documents is determined that correspond to processing the query by a search engine. A list of result queries is determined, wherein executing the list of result queries would correspond to a second list of documents, that result from presenting the result queries to the search engine, and the documents of the second list of documents cover the documents of the first list of documents. The list of result queries is returned as the suggested queries.

Determining a list of result queries may include, for example, determining a list of potential queries, wherein each potential query, when executed by the search engine, results in at least one document in the first list of documents; and processing the potential queries to determine which of the potential queries to include in the list of result queries.

### BRIEF DESCRIPTION OF THE DRAWINGS

FIG. 1 illustrates an example of an input query and a plurality of suggested queries.

FIG. 2 illustrates an example of the FIG. 1 input query and determined suggested queries that collectively cover all the documents that result from the input query and further, do not cover too many documents that do not result from the input query.

FIG. 3 is a graphical representation of a two-phase method to determine suggested queries.

FIG. 4 is a flowchart that illustrates an example method in accordance with a broad aspect to, in response to an initial search engine query, provide suggested queries whose results correspond to different topical groups.

FIG. 5 is a flowchart that broadly illustrates a “set cover” method to determine suggested queries.

FIG. 6 is a flowchart that broadly illustrates a cluster-based method to determine suggested queries.

FIG. 7 is architecture diagram of a system in which a method to determine suggested queries may operate to generate suggested queries based on an input query.

FIG. 8 is a simplified diagram of a network environment in which specific embodiments of the present invention may be implemented.

### DETAILED DESCRIPTION

The inventors have realized the desirability of, in response to an initial search engine query, providing suggested queries whose results correspond to different topical groups. Thus, for example, the results for the suggested queries may represent coherent, conceptually well-separated sets of documents, where the union of the sets covers substantially all the documents that would result from the initial search engine query. In more mathematical terms, given an initial query q, returns a set of suggested queries C so that each query in C is related to q and each query in C is about a distinct topic/aspect of q. For example, for an initial query “q” of “Barcelona,” it may be desired to determine the set of the following suggested queries “C”: barcelona tourism; barcelona culture; barcelona history; barcelona economy; and barcelona demographics.

In accordance with an aspect, the suggested queries are determined by solving a set-cover problem. The concept of the set-cover problem, generally, is well-known. Specifically, given a plurality of input sets, where each set may have some elements in common, the resultant sets comprise a minimum number of sets having the property that the elements of the resultant sets contain all the elements that are contained in any of the input sets.

In the query suggestion context (i.e., where it is desired to suggest queries based on an input query), the input sets to the set-cover problem may be considered to include sets of documents that result from potential suggested queries, where the potential suggested queries are queries that result in documents that also result from the input query. The documents that result from the input query may be determined, for example, by presenting the input query to a search engine. The potential suggested queries may be determined by inspecting a query log, matching documents resulting from the input query to documents that result from other queries, to determine which “other queries” result in documents that also result from the input query. The resultant output sets of the set-cover problem, in the query suggestion context, may include determined ones of the potential suggested queries such that the determines ones of the potential suggested queries collectively cover all the documents that result from the input query and further, in some examples, do not cover too many documents that do not result from the input query.

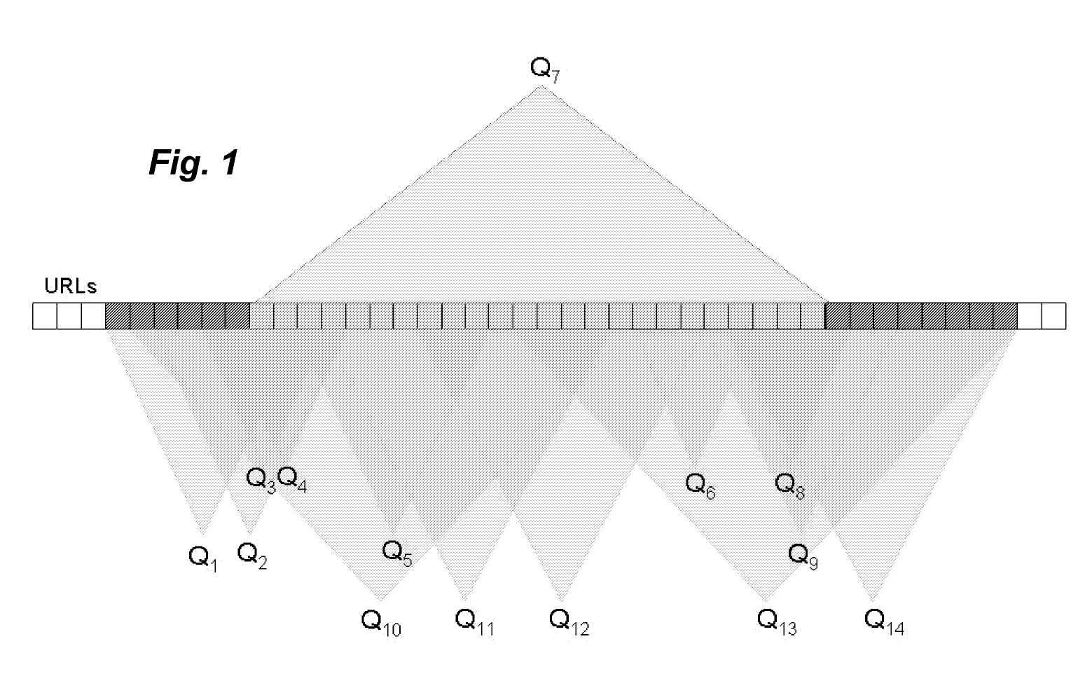

For example, FIG. 1 illustrates an example of an input query and a plurality of suggested queries. The input query is denoted as Q7. The set of URLs 102 indicate the universe of documents to which the input query Q7 is applied. For example, the set of URLs 102 may indicate the URLs of all documents that have been indexed by a search engine. The input query Q7 corresponds to a set of documents 104 that results from presenting the input query Q7 to a search engine. Furthermore, the queries Q1 to Q6 and Q8 to Q14 represent potential suggested queries.

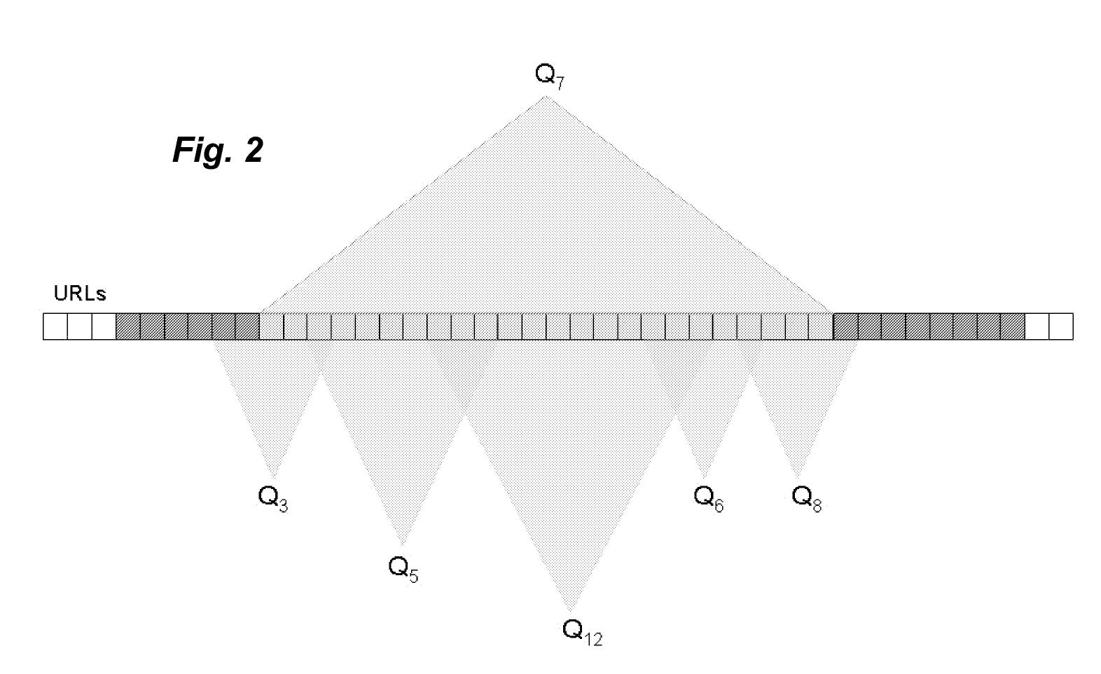

FIG. 2, on the other hand, illustrates an example of the input query Q7 and the determined suggested queries which, in this case, include Q3, Q5, Q12, Q6 and Q8. The determined suggested queries are those queries of the potential suggested queries that collectively cover all the documents that result from the input query and further, in this example, do not cover too many documents that do not result from the input query Q7.

We now discuss the determination of suggested queries in more mathematical terms. We consider a query log L, which is a list of pairs <q,D(q)>, where q is a query and D(q) is its result, i.e., a set of documents that answer query q. We denote with Q(q) the maximal set of queries pᵢ, where for each pᵢ, the set D(pᵢ) has at least one document in common with the documents returned by q, this is,

Q(q)={pᵢ|<pᵢ,D(pᵢ)>∈ L [symbol] D(pᵢ)∩ D(q)≠Ø}.

In the example shown in FIG. 1, the issued query is qᵢ=q₇ and Q(qᵢ)={q₁, . . . , q₁₄}. The goal is to compute a cover, i.e., selecting a subcollection C ⊂ Q(qᵢ) such that it covers almost all of D(qᵢ). As stated before, the queries in C should represent coherent, conceptually well-separated set of documents: they should have small overlap, and they should not cover too many documents outside D(qᵢ). One possible solution to the problem instance is shown in FIG. 2. What is not illustrated by this graphical representation is the topical coherence of each query, i.e., how compact is the set of documents it retrieves in the space of topics.

The subject of this patent application, broadly, topical query decomposition, has many potential applications, such as:
query filtering: it can be applied to an existing query recommendation system among others) to filter out recommendations that are topically too close to each other;
query diversification: it can produce a diversified set of recommendations, as some topical group needed to produce a good cover may be not so immediately similar to the given query (with respect to the similarity measures used by query recommendation systems) but still relevant for the user;
query-set: it can be used for selecting terms to represent a document set, following the query-set model;
query results presentation: it can be used to present the results of a given query with a different structure, for instance by picking the top document(s) from each representative query in the cover.
   These are just few examples in the context of web search applications, but topical query decomposition may find application in any information-seeking context where the users may be helped in better specifying what they are looking for.

Having broadly described applying a set cover approach to topical query decomposition, we now discuss two alternative sub-approaches: a top-down approach and a bottom-approach. The top-down approach, which is based on set-cover, starts with the queries in Q(q) and tries to handle the topical query decomposition as a special instance of a weighted set covering problem, where the weight of each query in the cover is given, for example, by: its internal topic coherence, the fraction of documents in D(q), the amount of documents it would retrieve that are not in D(q), as well as its overlap with other queries in the solution. The bottom-up approach is based on clustering. Starting from the documents in D(q), attempt is made to build clusters of documents which are compact in the topics space. Since the resulting clusters are not necessarily document sets associated with queries existing in L, a second phase may be used, in which the clusters found in the first phase are “matched” to the sets that correspond to queries in the query log.

We now discuss an abstract, general, formulation of the topical query decomposition “problem.” Each instance of the problem may be considered to include a set U of base points, formed by n blue points B={b₁, . . . , bₙ}, and m red points R={r₁, . . . , rₘ}, that is, U={b₁, . . . , bₙ, r₁, . . . , rₘ}. We write p ∈ U when we do not want to make the distinction if the point p of U is blue or red. A collection S of “1” sets over U is provided, so that S={S₁, . . . , Sₖ}, with Sᵢ ⊂ U. For every set Sᵢ ∈ S, we denote, Sᵢ^{B}=Sᵢ ∩ B are the blue points in Si; and Sᵢ^{R}=Si ∩ R are the red points in Si.

One part of the goal is to find a subcollection C ⊂ S that covers many blue points of U without covering too many red points. Thus, in one example described later, there are weights associated with the set of blue points; each blue point b ∈ B has a weight w(b) that indicates the relative importance of covering point b. Accordingly, the weighted cardinality of sets is defined to be the total weight of the blue points they contain: for each set S with blue and red points we define

$${\vert S \vert}_{W} = {\sum }_{\{ b ∈ {S}^{B} \}} w ( b )$$

User behavior in using query results, with respect to particular documents in the query results (e.g., clicking to view particular documents in a query result) may be a consideration in determining weights.

Another characteristic of our problem setting includes considering a distance function d(u, v), defined for any two points u, v ∈ U. A special case is when U ⊂ R^{t}, and the distance function d is the Euclidean distance or any other Lₚ-induced distance. The distance function d is used to define the notion of scatter sc(S) for the sets S ∈ S. Given a S, the scatter of S is define to be

$$sc ( S ) = {min}_{u ∈ S} {\sum }_{u ∈ S} {d ( u , v )}^{2}$$

This definition of scatter corresponds to the notion of 1-mean. Additionally, for example, one can also define scatter using the notions of 1-median, diameter, radius, or others. For our discussion we are also using the concept of coherence, which we do not define formally, but informally we refer to it as being the opposite of scatter. That is, a set of high scatter has small coherence, and vice versa.

A goal, then, may be stated as finding a subcollection C ⊂ S that covers almost all the blue points of U and has large coherence. More precisely, it is desired that C satisfies the following properties:

COVER-BLUE: C covers almost all blue points. The fraction of blue points covered is measured using the weights w(b), defined on the blue points b ∈ B.

NOT-COVER-RED: C covers as few red points as possible.

SMALL-OVERLAP: The sets in C have small overlap among themselves.

COHERENCE: The sets in C have small scatter (large coherence).

Having described an abstract, general, formulation of the topical query decomposition “problem,” we now discuss two approaches to addressing the problem. First, we discuss the set-cover based method and, second, we discuss the clustering-based method.

Turning now to a discussion of the set-cover based method, we note that two well-studied methods for solving variants of the set-cover problem are the “greedy” approach and Linear Programming (LP). The greedy approach appears to be more practically applied, though the LP method is also discussed here.

With respect to the greedy algorithm, one general greedy algorithm approach is described in V. Chvátal, A greedy heuristic for the set-covering problem, Mathematics of Operations Research, 4:233-235, 1979. However, this approach may not be directly applicable to the topical query decomposition problem, as discussed below. The general greedy algorithm approach achieves a O(log n) approximation ratio that matches the hardness of approximation lower bound. The basic greedy algorithm forms the cover solution by adding one element at a time. At the i-th iteration, if not all elements of the base set have been covered, the algorithm maintains a partial solution consisting of (i-1) sets, and it adds an i-th set by selecting the one that is locally optimal at that point. Local optimality is measured as a function of the costs of the candidate sets and the elements that have not been covered so far.

In order to instantiate such a general algorithm to the topical query decomposition problem, in one example, one takes into account the fact that the set of points under consideration includes blue and red points, that the blue points are weighted, the scatter scores sc(S) of the sets, as well as the requirements of cover-blue, notcover-red, small-overlap, and coherence. Given the above considerations, the basic greedy algorithm may be reformulated as shown below, in Algorithm 1.

Algorithm 1 Greedy

```
Input: Base set U = B ∪ R, weights w(b) of the blue points
    b ε B, set collection S = {S₁, ... , Sₗ}, scatter costs
    sc(S₁), ... , sc(Sₗ), cover parameter
Output: A cover C ⊂ S
1: V^{B} ← Ø
2: V^{R} ← Ø
3: C ← Ø
4: while |V^{B} ∩ B|_{w} < α |B|_{w} do
5:  Select S ∈ (S \ C) that minimizes s(S, V^{B}, V^{R})
6:  C ← C ∪ {S}
7:  V^{B} ← V^{B} ∪ S^{B}
8:  V^{R} ← V^{R} ∪ S^{R}
9: end while
10: Return C
```

Thus, for example, generally, the greedy algorithm operates to pick one-by-one from the candidate queries and to determine a score for each candidate query using a scoring function. Once a candidate is chosen (which is a “given” and is never then taken out from the list of chosen candidate queries), the algorithm iterates to choose from the remaining candidate queries until the chosen queries satisfy a criteria for completing the algorithm. The result is an ordered list of candidate queries, based on the score determined for the candidate queries.

The cover parameter controls the fraction of blue points that the algorithm aims at covering, and is measured in terms of the weights of the blue points. The score function s(S, V^{B}, V^{R}) is used to evaluate each candidate set S with respect to the elements covered so far by the current solution. For the score function s(S, V^{B}, V^{R}), a function is proposed that combines three terms:

$$s ( S , {V}^{B} , {V}^{R} ) = \frac{{λ}_{C} \cdot sc ( S ) + {λ}_{R} \cdot {\vert {S}^{R} \vert}_{w} + {λ}_{o} \cdot {\vert {S}^{B} ⋂ {V}^{B} \vert}_{w}}{{\vert {S}^{B} \backslash {V}^{B} \vert}_{w}}$$

where λ_{C}, λ_{R}, λ₀ are parameters that weight the relative importance of the three terms. The score function s(S, V^{B}, V^{R}) is motivated by the requirements of the problem and approximation algorithms for the set-cover algorithm.

As mentioned above, another method to solve a general set-cover problem includes linear programming, an example of which is now discussed, with particular application to the topical query decomposition problem characterized as a modified set-cover problem. In the example, an Integer Programming (IP) formulation of the of the set cover problem: for each set S ∈ S, a 0/1 variable xₛ is introduced, and the task is to

(1) minimize Σ_{S∈S}Xₛ·sc(S)

(2) subject to Σ_{s∈p}Xₛ≧1, for all p ∈ B,

(3) where xₛ ∈ {0, 1}, for all S ∈ S.

This integer program expresses the weighted version of set cover. A solution can be obtained by relaxing the integrality constraints (3) to (3′): {0≦xₛ—1}, solving the resulting linear program, and then rounding the variables xₛ obtained by the fractional solution. The resulting solution is a O(log n) approximation to the weighted set cover problem. For example, see V. Vazirani, Approximation Algorithms. Springer, 2004.

One way to allow small overlaps among the sets of the cover produced as a solution is to require that each one of the blue points is covered by only a few sets. Such a constraint can be represented as

$${\sum }_{S ∈ p} {x}_{s} \leq c , for all p ∈ B \qquad ( 4 )$$

for some constant c≧2, enforcing that each point will be covered by at most c sets.

It can be shown that by solving the linear program {(1), (2), (4)} and performing randomized rounding to obtain an integral solution provides again an O(log n) approximation algorithm, in which the constraint (4) is inflated by a factor of log n, that is, each point in the final solution belongs to at most c log n sets. The proof is a somewhat straightforward easy adaptation of the basic proof that shows the O(log n) approximation for the set cover problem via randomized rounding.

It is also considered to add constraints to satisfy the NOTCOVER-RED property: for each red point r ∈ R, by introducing a 0/1 variable yᵣ. There are then required that at most d red points are covered by

$${\sum }_{r ∈ R} {y}_{r} \leq d \qquad ( 5 )$$

ensuring that whenever a set S is selected, the variables yᵣ for all red points r ∈ S^{R} are set to 1, by

yᵣ≧xₛ, for all r ∈S^{R} (6)

The program {(1), (2), (4), (5), (6)} can be either solved directly by an IP-solver, or again, relax the integrality constraints, solve the corresponding LP, and round the fractional solution.

Having described a top-down approach to topical query decomposition, which is based on set-cover, we now describe a bottom-up approach, based on clustering. In one example, broadly speaking, the clustering-based method is a two-phase approach. In the first phase, all points in the set B are clustered using a hierarchical agglomerative clustering algorithm. During this clustering phase, the points in B are clustered with respect to the distance function d, while the information about the sets in the collection S, as well as the information about points in R is ignored. At any given level of the hierarchy the induced clustering intuitively satisfies the requirements of our problem statement: the clusters are non-overlapping, they have high coherence, they are covering the points in B, and no points in R. An issue is that those clusters are not necessarily corresponding to the sets of the collection S. Thus, in the second phase, there is attempt to match the clusters of the hierarchy produced by the agglomerative algorithm with the sets of S.

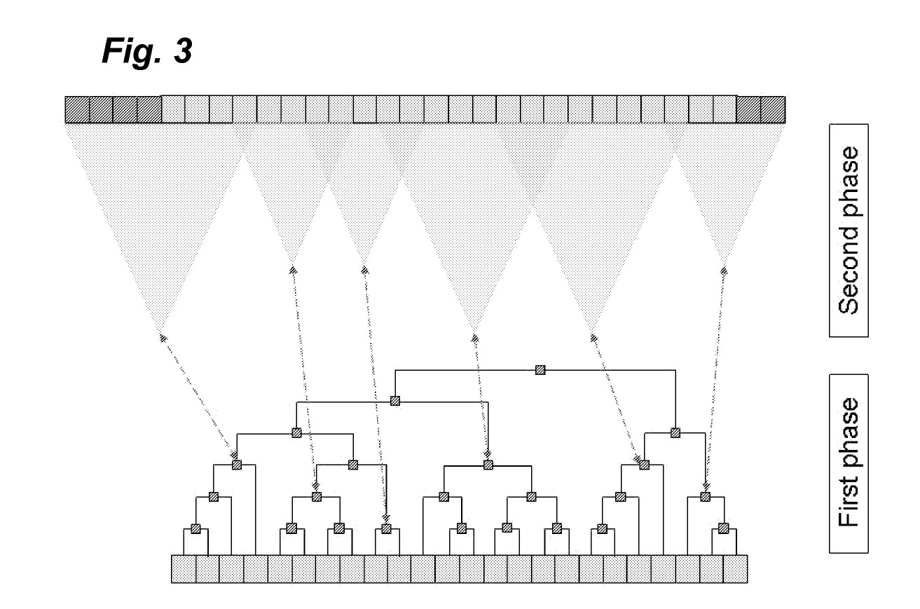

A graphical representation of the two-phase method is shown in FIG. 3. Next we the two-phase algorithm is described in more detail with reference to FIG. 3. For the hierarchical clustering phase, in one example, the method introduced in Y. Zhao and G. Karypis, Evaluation of hierarchical clustering algorithms for document datasets, In Proceedings of the 2002 ACM int. conf. on Information and Knowledge Management, (CIKM'02), pages 515-524, 2002, is adopted. This method is available in the “Cluto toolkit,” available from George Karypis, an Associate Professor at the Department of Computer Science & Engineering at the University of Minnesota (see, e.g., http://glaros.dtc.umn.edu/gkhome/views/cluto). This method has been shown to outperform traditional agglomerative algorithms when clustering document datasets.

In this method, the agglomeration process is biased by a hierarchical divisive clustering solution that is initially computed on the dataset. This is done with the aim of reducing the impact of early-stage errors made by the agglomerative method, thus producing higher quality clustering.

In one example, the method begins with a divisive clustering until \sqrt{n} clusters are formed, where n is the number of objects to be clustered. Then, it augments the original feature space by adding \sqrt{n} new dimensions, one for each cluster. Each object is then assigned a value to the dimension corresponding to its own cluster, and this value is proportional to the similarity between that object and its cluster-centroid. Given this augmented representation, the overall clustering solution may be obtained by using the traditional agglomerative paradigm with the upgma (Unweighted Pair Group Method with Arithmetic mean) clustering criterion function, such as described in P.-N. Tan, M. Steinbach, and V. Kumar. Introduction to Data Mining. Addison-Wesley, 2005.

Once this method has been performed over the set of points B, it produces a dendrogram τ whose leaves are the points in B and every node T ∈ τ corresponds to a cluster. (A dendomgram is a tree for classification of similarity, commonly used in biology.) Let τ (B) be the set of points in B the correspond to the cluster associated with node T ∈τ, or in other terms, the leaves of the subtree rooted in T. Moreover, we denote by child_of(T) the list of children of T in τ.

The objective of the second phase is to select the sets C ⊂ S according to the requirements of the original problem statement—large coverage of B, small coverage of R, small overlap of sets in C, and large coherence. This is done by exploiting the clustering produced in the first phase in to order to facilitate the selection of the sets C. A goal, then, is to match sets of S into clusters of τ. In the following, it is described how the matching may be performed. For sake of simplicity, it is first described how to perform, in one example, the matching in order to achieve complete coverage of B by means of dynamic programming. Then the dynamic programming algorithm is modified to handle the case of partial coverage.

With respect to complete coverage, for each set S ∈ S and each node T ∈τ a matching score m(T, S) between S and T is defined to be as follows:

m(T, S)=sc(S), if T^{B}⊂S^{B} or, otherwise, =∞.

That is, clusters T of τ are matched only to sets S that properly contain the clusters, and the cost is the scatter cost of S. Given a cluster T ∈τ m*(T) denotes the score of the best matching set in S. In other words, the following definition is made:

$$m * ( T ) = {min}_{S ∈ s} \{ m ( T , S ) \}$$

Now we solve the assignment problem from nodes of τ to sets in S by dynamic programming on the tree T in a bottom-up fashion. For example, let M(T) bet the optimal cost of covering the points of T^{B} with sets in S. We have

$$M ( T ) = min \{ m * ( T ) , {\sum }_{R ∈ child\_of ( T )} M ( R )$$

The meaning of the above equation is that, for each cluster T that is considered in a bottom-up fashion in τ is either matched to a new covering set S—the one with the least cost—or use the solutions obtained for the children of T are used to make up the covering for T. From the two options, the one with the least cost is selected.

A motivation of the algorithm, in terms of the requirements of the problem statement, is as follows:

COVER-BLUE: By assigning infinite costs to sets that do not contain clusters, any complete cover has lower cost than any partial cover.

NOT-COVER-RED: This requirement is achieved since sets that cover many red points tend to have higher scatter cost.

SMALL-OVERLAP: Again, sets with large overlap tend to contribute more to the scatter cost objective function.

COHERENCE: The objective function of the matching tries to minimize explicitly the total scatter cost.

PARTIAL COVERAGE: In almost all of the problem instances encountered in our dataset, it is not possible to cover all of the original set of blue points B, with the sets in S. Furthermore, even if a complete cover were possible, it might not be the case that the clusters in the hierarchy tree T are covered by the sets in S. Therefore, we adjust the matching algorithm in order to make it work with partial coverage.

In the general case, we relax the constraint that each cluster should be properly contained in the sets of S by adding a penalization term for the z points that are left uncovered. In particular, we define

m(T, S)=sc(S)+λ_{U}·(|T^{B}\S^{B}|)²,

for all sets T ∈τ and S ∈ S. For the cases of proper containment, T^{B} ⊂ S^{B}, the above matching score gives m(T, S)=sc(S), as in the case of complete coverage. However, if T^{B} ⊂ S^{B}, the above score function penalizes gradually for the points of T^{B} not covered by S^{B}. Penalizing according to the square of the number of uncovered points was chosen among other choices by subjectively reviewing the results of the algorithm on a sample dataset. The parameter λ_{U} weights the relative importance between the two terms, the scatter cost of the sets S and the number of uncovered points. Again, as for the parameters λ of the greedy set cover algorithm, the value of λ_{U} is selected heuristically, such as to be learned via training data for a specific application at hand. In one experiment, the behavior of the algorithm is studied for various measures of interest as a function of the control parameter λ_{U}.

Given the modified definition of m(T, S), the dynamic programming algorithm for the case of partial coverage is, in one example, identical to the case of complete cover.

Having described somewhat abstractly examples of methods that may be utilized to accomplish set cover generally, we now discuss particular examples of applying the methods to actual query logs. In one example, reference is made to a query log [symbol] that includes a log of 2.9 million distinct queries. It has been observed that many search engine users only look at the first page of presented search results, while few users request additional pages of search results. For each query q, the maximum result page to which any user asking for q in the query log navigated is recorded, and the set of result documents for the query is considered, which is denoted by D(q). It is emphasized that in contrast to most of the research on query log mining, the present methodology in one example uses all the documents that are shown to the users, and not only the ones that are chosen (e.g., by clicking).

Overall, in the sample dataset, there are 24 million distinct documents seen by the users. This means that there is certain overlap between the result sets of different queries; otherwise, given that users see at least ten documents per query, there would be at least 29 million distinct documents if there were no overlap.

With regard to determining candidate queries for the cover, for query q, a set of candidate queries is built for q. The candidate queries Qₖ(q) are ones that have sufficient overlap with the original query, namely:

Qₖ(q)={pᵢ| [symbol] pᵢ,D(pᵢ) [symbol] ∈ [symbol] |D(pᵢ) ∩ D(q)|≧k}.

In the following, we set k=2 meaning that each candidate query pᵢ should have at least 2 documents in common with the original query q.

A first question is whether there are enough candidates in the query log [symbol] for a given query q. In practice, the answer depends basically on the size of |D(q)|. For example, generally about |D(q)|/2 candidates for each query returning |D(q)| documents is sufficiently large to represent different topical aspects on each query.

The size of the maximum cover attainable with this set of candidates is also checked. According to the observations, this may be a fairly stable fraction of about 60%-70% across all queries that have at least 20 documents seen.

Next, the scatter is computed for each candidate query as

$$sc ( D ( {p}_{i} ) ) = {min}_{u ∈ {D}_{{p}_{i}}} {\sum }_{v ∈ {D}_{{p}_{i}}} {d ( u , v )}^{2}$$

For defining the distance between two documents d(u, v) in the result set of a candidate query there are many choices. Given that there is a potentially large set of candidate queries pᵢ for any query q, each one of them having potentially many documents, and given that we are interested only on an aggregate if the distances, we decided to use a coarse-grained metric. Our choice was to use a text classifier to project each document into a space of topics (100 distinct topics), and then use as d(.,.) the Euclidean distance between the topic vectors.

For the distance between two documents d(u, v) in the result set of the original query q, a more fine-grained metric is used. Stopwords are removed, stemming is performed, and tf·idf weights are computed for each term in each document. See, for example, R. Baeza-Yates and B. Ribeiro-Neto. Modern Information Retrieval, Addison Wesley, 1999. Using this document representation, we used the standard cosine similarity as the distance function during the agglomerative clustering process.

Finally, the weight w(d) of a document d ∈ D(q) is given by the number of clicks the document has received when presented to the users in response to query q. The distribution of clicks is very skewed (e.g., see N. Craswell, O. Zoeter, M. Taylor, and B. Ramsey, An experimental comparison of click position-bias models, In Proceedings of the international conference on Web search and web data mining (WSDM'08). Many documents that are seen by the users have no clicks, so the following weighting function is used:

w(d)=log₂(1+clicks(q, d))+1,

where clicks(q, d) is the number of clicks received by document d when shown in the result set of query q.

We now discuss some experimental results. In particular, we picked uniformly at random a set of 100 queries out of the top 10,000 queries submitted by users, and ran the algorithms discussed herein over those queries. Given that the greedy algorithm stops when it reaches the maximum coverage possible and queries have different cover sizes, we fixed a cover set size k and evaluated the results of the top-k queries picked by each algorithm, using the following measures:

Cost at k: sum of costs of the k queries in the cover.

Red points at k: the number of documents included outside the set D(q) in the solution, as a fraction of the total number of documents outside the set D(q).

Overlap at k: average number of queries covering each element in the solution.

Coverage at k: coverage after the top k candidates have been picked.

The average results for the set cover method described above are summarized in Table 1 for several parameter settings.

TABLE 1
Average results for the greedy algorithm at cover size |C| = 5.

| Parameters | | | Sum of | Red | Inter-query | |
|---|---|---|---|---|---|---|
| λ_{C} | λ_{R} | λ_{O} | costs | fraction | overlap | Coverage |
| 0 | 0 | 1 | 0.11 | 0.15 | 1.07 | 0.47 |
| 0 | 1 | 0 | 0.06 | 0.04 | 1.53 | 0.48 |
| 0 | 1 | 1 | 0.06 | 0.06 | 1.11 | 0.44 |
| 1 | 0 | 0 | 0.03 | 0.06 | 1.32 | 0.43 |
| 1 | 0 | 1 | 0.04 | 0.08 | 1.10 | 0.40 |
| 1 | 0 | 10 | 0.05 | 0.09 | 1.09 | 0.39 |
| 1 | 1 | 0 | 0.05 | 0.04 | 1.41 | 0.47 |
| 1 | 1 | 1 | 0.05 | 0.07 | 1.13 | 0.44 |
| 1 | 10 | 0 | 0.06 | 0.04 | 1.51 | 0.47 |
| 1 | 10 | 10 | 0.05 | 0.06 | 1.12 | 0.44 |
| 10 | 0 | 1 | 0.04 | 0.08 | 1.17 | 0.42 |
| 10 | 1 | 0 | 0.03 | 0.05 | 1.33 | 0.44 |
| 10 | 1 | 1 | 0.04 | 0.07 | 1.16 | 0.43 |
| | | | | | max. | 0.61 |

From the results of set-cover shown in Table 1, it is observed that penalizing only the overlap does not yield good results, and the results are improved if either the scatter of the queries or the red points are taken into account.

For the clustering-based method described above, results are summarized in Table 2.

TABLE 2
Average results for the clustering-based algorithm.

| Parameter | Size | Sum of | Red | Inter-query | |
|---|---|---|---|---|---|
| λ_{U} | \|C\| | Costs | Fraction | overlap | Coverage |
| 2⁰ | 1.00 | 0.00 | 0.01 | 1.00 | 0.06 |
| 2⁶ | 2.15 | 0.01 | 0.02 | 1.13 | 0.12 |
| 2⁷ | 2.78 | 0.01 | 0.03 | 1.21 | 0.14 |
| 2⁸ | 3.56 | 0.01 | 0.03 | 1.25 | 0.16 |
| 2⁹ | 4.52 | 0.02 | 0.04 | 1.31 | 0.20 |
| 2¹⁰ | 5.63 | 0.02 | 0.05 | 1.38 | 0.23 |
| 2¹¹ | 7.70 | 0.03 | 0.07 | 1.55 | 0.29 |
| 2¹² | 10.11 | 0.05 | 0.09 | 1.68 | 0.34 |
| 2¹³ | 14.48 | 0.08 | 0.14 | 1.90 | 0.43 |
| 2¹⁴ | 18.06 | 0.13 | 0.18 | 2.06 | 0.50 |
| | | | | max | 0.61 |

Here, the size of the cover varies with the parameter λ_{U}. For small values of λ_{U}, there is not sufficient penalization for partial coverage, and thus the resulting solutions tend to involve only few queries that do not cover well the set D(q). As the value of λ_{U} increases, more sets are selected in the cover solution. It is observed that the results of the clustering method are worse than the ones obtained by the set-cover method. Looking at Table 2 for average cover sizes |C| between 4.52 and 5.63, it can be seen that the coverage reached is about half of the coverage than the set-cover method at 5 obtains in Table 1, at a comparable level of cost for the solution.

In conclusion, then, we have described a method of topical query decomposition, which is a novel approach that stands in between query recommendation and clustering the results of a query, having simultaneous and important differences from both. A general formulation has been described, along with two elegant solutions, namely red-blue metric set cover and clustering with predefined clusters.

Having described some algorithms usable to determine suggested queries based on solving a set-cover problem, we recap by presenting flowchart that summarizes a broad approach to determining suggested queries in this manner, as well as flowcharts that summarize examples of more detailed approaches.

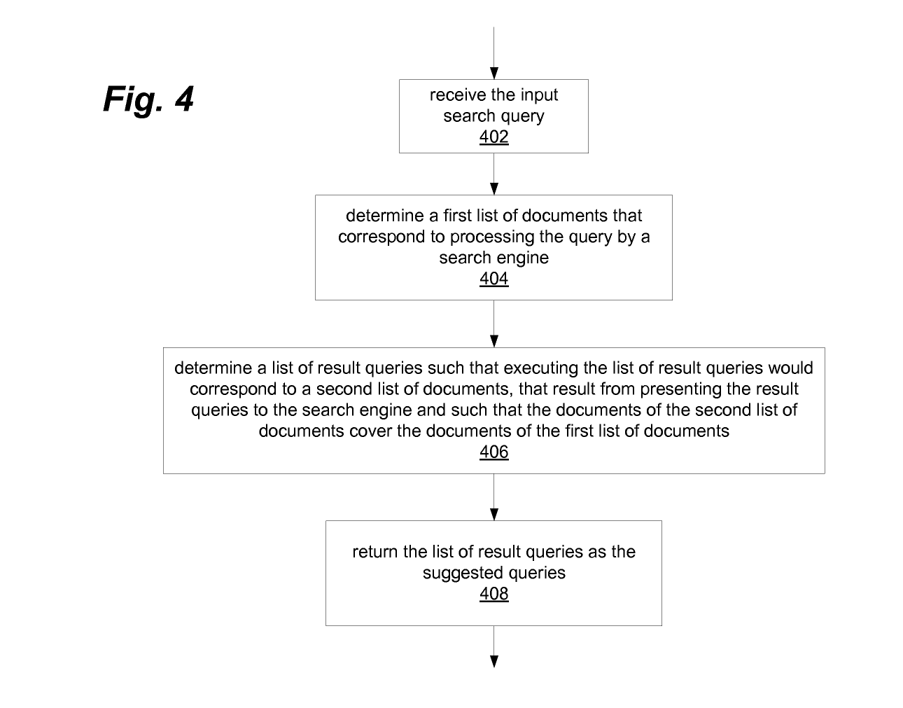

Referring to FIG. 4, a flowchart is provided that illustrates an example method in accordance with a broad aspect to, in response to an initial search engine query, providing suggested queries whose results correspond to different topical groups. At 402, the search engine query is received. For example, the search engine query may be provided via a web page input portion, a toolbar, or various other methods. In general, though this is not required, the search engine query is provided based on input from a user, such as being typed by the user using a keyboard of a computing device.

At 404, a first list of documents is determined that correspond to processing the query by a search engine. For example, the search engine query may be actually provided to and processed by the search engine, wherein the search engine would provide the first list of documents. As another example, the search engine query may have been previously processed by the search engine (such as a result of having been presented by another user), and the documents resulting from that previous processing may be determined to be the first list of documents.

At 406, a list of result queries is determined, where the result queries are such that executing the list of result queries would correspond to a second list of documents that result from presenting the result queries to the search engine and such that the documents of the second list of documents cover the documents of the first list of documents. At 408, the list or result queries determined in 406 are returned as suggested queries.

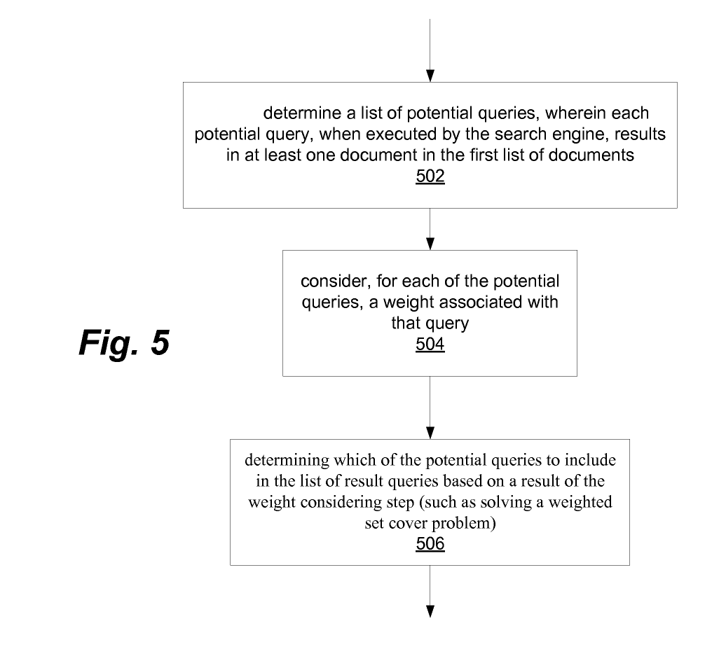

One method to determine the result queries (a “set cover” method) is broadly described now with reference to the flowchart in FIG. 5. At 502, a list of potential queries is determined, wherein each potential query, when executed by the search engine, results in at least one document in the first list of documents (i.e., in the list of documents that would result from presenting the input search engine query to a search engine). For example, the potential queries may be determined by inspecting a search engine log, matching documents in the first list of documents to queries having a result with at least one document in the first list of documents.

At 504, for each of the potential queries, a weight associated with that potential query is considered, where the weight is determined with respect to the documents resulting (or that would result) from that potential query. For example, as discussed above, the weight for a potential query may be given by: its internal topic coherence, the fraction of documents in the first list of documents, the amount of documents it would retrieve that are not in the first list of documents, as well as its overlap with other queries in the solution. At 506, it is determined which of the potential queries to include in the list of result queries based on a result of considering the weights associated with the potential queries (such as by solving a weighted set cover problem).

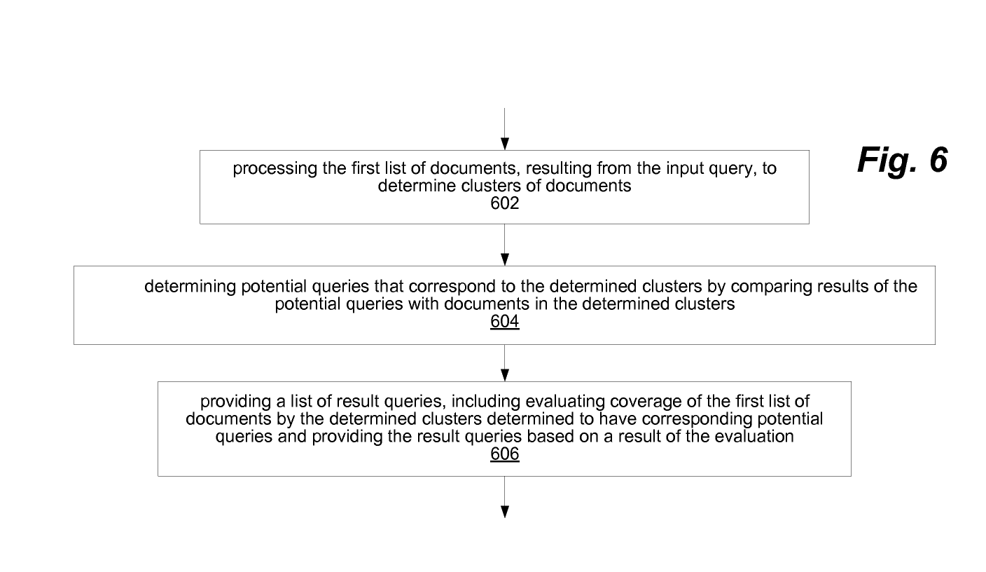

Another method to determine the result queries (a cluster-based method) is broadly described now with reference to the flowchart in FIG. 6. At 602, a first list of documents, resulting from the input query, is processed to determine clusters of documents. For example, the processing may be according to a hierarchical agglomerative clustering algorithm. At 604, potential queries are determined that correspond to the determined clusters by comparing results of the potential queries with documents in the determined clusters. At 606, a list of result queries is provided, including evaluating coverage of the first list of documents by the determined clusters determined to have corresponding potential queries. The result queries are provided based on a result of the evaluation.

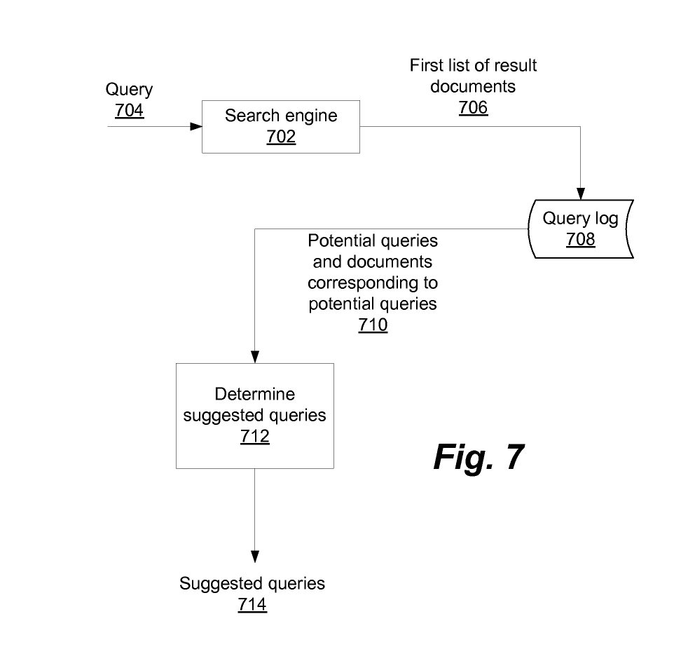

FIG. 7 is an architecture diagram of a system in which a method to determine suggested queries may operate to generate suggested queries 714 based on an input query 704. Referring to FIG. 7, a search engine service 802 receives the input query 704 and provides a first list 706 of result documents. Based on a query log 708 and the first list 706 of result documents, potential queries and a list of documents corresponding to the potential queries (collectively, 710) are provided to a module 712 (which may be, for example, but need not be, closely coupled to the search engine service 702) to determine the suggested queries 714.

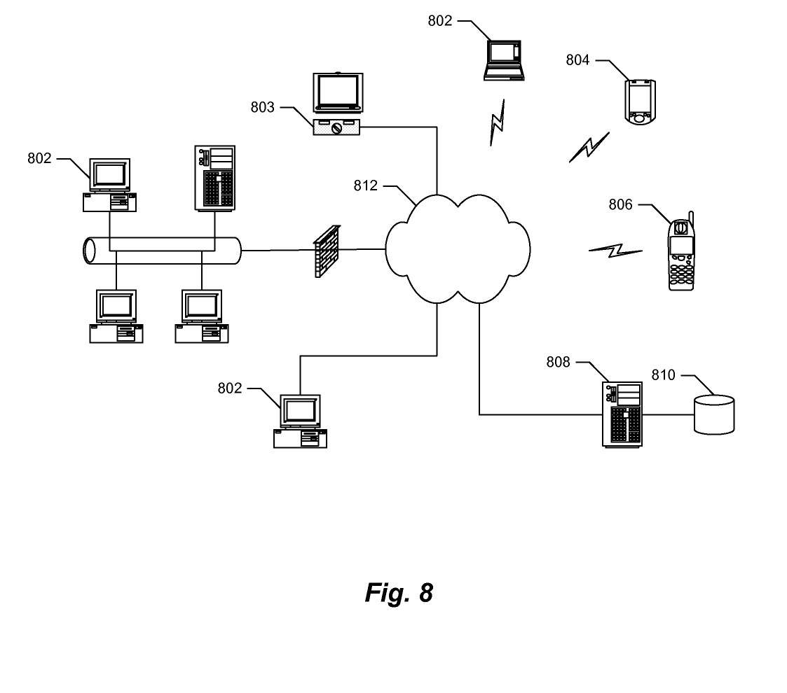

Embodiments of the present invention may be employed to facilitate evaluation of binary classification systems in any of a wide variety of computing contexts. For example, as illustrated in FIG. 8, implementations are contemplated in which users may interact with a diverse network environment via any type of computer (e.g., desktop, laptop, tablet, etc.) 802, media computing platforms 803 (e.g., cable and satellite set top boxes and digital video recorders), handheld computing devices (e.g., PDAs) 804, cell phones 806, or any other type of computing or communication platform.

According to various embodiments, applications may be executed locally, remotely or a combination of both. The remote aspect is illustrated in FIG. 8 by server 808 and data store 810 which, as will be understood, may correspond to multiple distributed devices and data stores.

The various aspects of the invention may also be practiced in a wide variety of network environments (represented by network 812) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A computer-implemented method to provide suggested search queries based on an input search query, the method comprising:
receiving the input search query;
determining a first list of documents that correspond to processing the query by a search engine;
determining a list of result queries, wherein:
executing the list of result queries would correspond to a second list of documents, that result from presenting the result queries to the search engine; and
the documents of the second list of documents cover the documents of the first list of documents; and
returning the list of result queries as the suggested queries.

2. The method of claim 1, wherein determining a list of result queries includes:
determining a list of potential queries, wherein each potential query, when executed by the search engine, results in at least one document in the first list of documents; and
processing the potential queries to determine which of the potential queries to include in the list of result queries.

3. The method of claim 1, wherein:
the list of result queries are such that, for each of the result queries, documents of the second list that correspond to that result query exhibit high coherence and have small overlap with documents of the second list that correspond to the other result queries, and the documents of the second list collectively cover almost all of the documents of the first list and cover few documents not in the first list.

4. The method of claim 2, wherein determining a list of result queries includes:
processing potential queries, wherein each potential query, when executed by the search engine, results in at least one document in the first list of documents, the processing potential queries includes considering, for each of the potential queries, a weight associated with that potential query; and
determining which of the potential queries to include in the list of result queries based on a result of the considering step.

5. The method of claim 4, wherein:
for each potential query, the weight associated with that potential query is indicative of at least internal topic coherence of that query, the number of documents resulting from that potential query that are also in the first list of documents, the number of documents resulting from that potential query that are not in the first list of documents, an amount of overlaps of the documents resulting from that potential query with documents resulting from others of the potential queries

6. The method of claim 1, wherein:
potential queries, when executed by the search engine, result in at least one document in the first list of documents; and
determining the list of result queries includes processing the potential queries according to a greedy algorithm as applied to sets of documents corresponding to the potential queries, relative to the first list of documents and to the second list of documents.

7. The method of claim 1, wherein:
potential queries, when executed by the search engine, result in at least one document in the first list of documents; and
determining the list of result queries includes
iteratively processing the sets of result documents for the potential queries iteratively to determine, at each iteration, a partial solution for the second set of documents by adding one of the sets of result documents to the partial solution determined in the immediately previous iteration, wherein the potential query corresponding to the added one set of result documents is added to a partial list of result queries determined in the immediately previous iteration; and
evaluating the partial solution at each iteration and, when the partial solution meets a suitability criteria, treating the partial list of result queries from that iteration as the determined list of result queries.

8. The method of claim 7, wherein:
the one of the set of results documents added to the partial solution for the second set of documents determined in the immediately previous iteration is determined as a cost function of
the remaining sets of result documents not already in the partial solution determined in the immediately previous iteration; and
the documents in the second set of documents that are not in the partial solution determined in the immediately previous iteration.

9. The method of claim 7, wherein:
the suitability criteria is a function of the number of documents in the first set of documents that are not in the partial solution.

10. The method of claim 1, wherein
potential queries, when executed by the search engine, result in at least one document in the first list of documents; and
determining the list of result queries includes processing the potential queries according to a linear programming algorithm as applied to sets of documents corresponding to the potential queries, relative to the first list of documents and to the second list of documents.

11. A computing system configured to provide suggested search queries based on an input search query, the computer system configured to:
receive the input search query;
determine a first list of documents that correspond to processing the query by a search engine; and
determine a list of result queries, wherein:
executing the list of result queries would correspond to a second list of documents, that result from presenting the result queries to the search engine; and
the documents of the second list of documents cover the documents of the first list of documents,
wherein determining the list of result queries includes
consulting a query log to determine a list of potential queries, wherein each potential query, when executed by the search engine, results in at least one document in the first list of documents; and
processing the potential queries to determine which of the potential queries to include in the list of result queries; and
the system further configured to return the list of result queries as the suggested queries.

12. The computing system of claim 11, wherein:
the list of result queries are such that, for each of the result queries, documents of the second list that correspond to that result query exhibit high coherence and have small overlap with documents of the second list that correspond to the other result queries, and the documents of the second list collectively cover almost all of the documents of the first list and cover few documents not in the first list.

13. The system of claim 11, wherein the computing system1 being configured to determine a list of result queries includes:
the computing system being configured to process potential queries, wherein each potential query, when executed by the search engine, results in at least one document in the first list of documents, the processing potential queries includes considering, for each of the potential queries, a weight associated with that potential query; and
the computing system being configured to determined which of the potential queries to include in the list of result queries based on a result of the considering.

14. The system of claim 13, wherein:
for each potential query, the weight associated with that potential query is indicative of at least internal topic coherence of that query, the number of documents resulting from that potential query that are also in the first list of documents, the number of documents resulting from that potential query that are not in the first list of documents, an amount of overlap of the documents resulting from that potential query with documents resulting from others of the potential queries

15. The computing system of claim 11, wherein:
being configured to determine the list of result queries includes being configured to process the potential queries according to a greedy algorithm as applied to sets of documents corresponding to the potential queries, relative to the first list of documents and to the second list of documents.

16. The computing system of claim 11, wherein:
being configured to determine the list of result queries includes
being configured to iteratively process the sets of result documents for the potential queries iteratively to determine, at each iteration, a partial solution for the second set of documents by adding one of the sets of result documents to the partial solution determined in the immediately previous iteration, wherein the potential query corresponding to the added one set of result documents is added to a partial list of result queries determined in the immediately previous iteration; and
being configured to evaluate the partial solution at each iteration and, when the partial solution meets a suitability criteria, treating the partial list of result queries from that iteration as the determined list of result queries.

17. The computing system of claim 16, wherein:
the one of the set of results documents added to the partial solution for the second set of documents determined in the immediately previous iteration is determined as a cost function of
the remaining sets of result documents not already in the partial solution determined in the immediately previous iteration; and
the documents in the second set of documents that are not in the partial solution determined in the immediately previous iteration.

18. The computing system of claim 16, wherein:
the suitability criteria is a function of the number of documents in the first set of documents that are not in the partial solution.

19. The computing system of claim 11, wherein
potential queries, when executed by the search engine, result in at least one document in the first list of documents; and
being configured to determine the list of result queries includes being configured to process the potential queries according to a linear programming algorithm as applied to sets of documents corresponding to the potential queries, relative to the first list of documents and to the second list of documents.

20. A tangible computer-readable medium having computer program instructions recorded tangibly thereon, the computer program instructions to configure a computing system comprising at least one computing device to provide suggested search queries based on an input search query, the computer program instructions to configured the computing system to:
receive the input search query;
determine a first list of documents that correspond to processing the query by a search engine; and
determine a list of result queries, wherein:
executing the list of result queries would correspond to a second list of documents, that result from presenting the result queries to the search engine; and
the documents of the second list of documents cover the documents of the first list of documents,
wherein determining the list of result queries includes
consulting a query log to determine a list of potential queries, wherein each potential query, when executed by the search engine, results in at least one document in the first list of documents; and
processing the potential queries to determine which of the potential queries to include in the list of result queries; and
the computer program instructions further to configure the computing system to return the list of result queries as the suggested queries.
